(19) United States
(12) Patent Application Publication
(10) Pub. No.: US 2009/0187424 A1
(43) Pub. Date: Jul. 23, 2009

(54) System and method for monitoring and recording locations of medical products and applications thereto

(76) Inventor: Matthew L. Grabowski, Atlanta, GA (US)

Correspondence Address: MCKENNA LONG & ALDRIDGE LLP, 1900 K STREET, NW, WASHINGTON, DC, 20006, US

(21) Appl. No.: 12/010,220

(22) Filed: Jan. 22, 2008

(51) Int. Cl. G06Q 50/00

(52) U.S. Cl. 705/3; 705/2

(57) ABSTRACT

A system for autonomous monitoring of administration of prescribed items for patients may include a plurality of wireless locator tags each having an indicator coupled thereto, an indoor positioning system, a database, a processor, and a radio transceiver. A method for autonomous monitoring of administration of prescribed items for patients may include detecting a contemporaneous collocation of a prescribed item and a patient, verifying that the identity of the prescribed item is equivalent to a prescribed item recorded in a physician's order for the patient, determining if the prescribed item is supplied in a correct dose and at a correct time, recording the identities of staff members in contemporaneous collocation to the patient, and commanding a locator tag coupled to a container holding the prescribed item to annunciate either an error condition if the prescribed item, dosage, or time of administration is not consistent with the physician's order, or a no error condition if the prescribed item, dosage, and time of administration are consistent with the physician's order.

### BACKGROUND OF THE INVENTION

1. Field of the Invention

The present invention is directed to systems and methods for monitoring data related to a spatial relationship between persons and products and using the data, in conjunction with data from one or more databases, to provide an indication of authorization for the potential administration, by a practitioner, of a subset of the products to an individual in proximity of the products.

More specifically, the present invention is directed to systems and methods for autonomous, continuously updated, real-time monitoring of data related to a spatial relationship between medical practitioners, patients, and medical products and using the data, in conjunction with data from one or more databases, such as patient and pharmacy databases, to provide an indication of authorization for the potential administration, by the practitioner, of a subset of the medical products to an individual patient in proximity of the medical products.

2. Background of the Related Art

Technology exists that allows real-time (on the order of seconds or less), accurate (within about 10 feet) physical location determination of locator tags in an indoor facility, such as a hospital. The location of a person or object (e.g., a piece of capital equipment) can be determined if a locator tag is affixed to the person or object. Two commercially available indoor location determination systems, the Ekahau Positioning Engine and the Aeroscout Visibility System, are known to be operable in hospital settings. Other commercially available indoor location determination systems may also be useful in a hospital setting, including those made by Pango and Sonitor. The former mentioned systems are attractive because they use wireless network infrastructure that already exists in hospital settings and therefore require the installation of a minimum of additional equipment. Systems using existing wireless networks typically determine the position of the locator tag in real-time and at short intervals. The locator tags include Wi-Fi (or other wireless communication protocol) enabled devices, badges, small tags, or the like. Systems using existing wireless networks are also attractive because they allow two-way communication between each wireless enabled locator tag and a base system.

In today's hospitals, a medical doctor may execute a “Physician's Order” for a patient. The Physician's Order includes, at least, a patient's name; a name of a pharmaceutical or other item such as a blood product; an amount to be administered; a time period for administration; and a duration (subsequent to which the patient need not take the drug, medication, or blood product any longer). Drugs or medications as used herein include all types whether applied to the skin, ingested, injected, or inserted into a patient. Drugs or medications as used herein also include drugs or medications in intravenous solutions (IV) prepared by the pharmacy and contained in IV bags, whose contents will be administered to a patient via an IV, or other appropriate, line. As used herein, containers, such as IV bags, containing blood products are within the scope of the invention. Accordingly, as used herein the terms “drug” “medication” and “blood product” may individually or collectively be referred to as a “prescribed item.” Of course, prescribed items are not limited to these three exemplary products. In addition, for ease of reference, as used herein the terms “pharmacy” or “blood bank” may individually or collectively be referred to as “pharmacy.”

Prescribed items, in all forms, are typically dispensed by pharmacy personnel. Prescribed items are typically dispensed in containers, which may include IV-bags, vials, single-use containers, re-sealable containers, cups, and envelopes. The containers are labeled with, at least, the name or other identifier of the prescribed item contained therein, dosage, date, time, and patient's name. Other information may also be included. The pharmacy personnel that dispense the prescribed items are responsible for accurately labeling each container holding a prescribed pharmaceutical. Pharmacy personnel are also responsible for accurately interpreting the Physician's Order and placing the correct prescribed item in the accurately labeled container. In known hospitals, the labeled containers for a single patient are typically placed in a single tray (open or closed). The single tray, for a single patient, may be labeled (or otherwise marked) with identification information that may include the patient's name, floor, and room number. The single labeled tray may be collected together with other trays for patients in nearby rooms, wards, or floors of the hospital. The collection of individually labeled trays may be placed on or in a dispensing cart, which may be wheeled from room to room.

The hospital's health care providers, but typically the nursing staff, are responsible for distributing and administering the containerized prescribed items among the patients. The health care providers are also responsible for ensuring that each patient receives only the prescribed item identified on the Physician's Order, in the correct amount, and within the predetermined time period.

In such a distributed system, there is an inherent chance for human error as, at least, many people handle the prescribed items (often with varying degrees of training), and many patients receive prescribed items that have similar appearance, and have similar names. Errors due to the delivery of a non-prescribed item (such as a drug, medication, or blood product) to a patient, while rare, are potentially fatal and carry with them the risk of litigation. The Joint Commission on Accreditation of Healthcare Organizations (JCAHO) has made the prevention of drug or medication delivery errors a major focus.

In a process similar to this, blood products (e.g., red blood cells, plasma, platelets) released from the blood bank are extensively checked and labeled to prevent errors. Hospital blood banks thoroughly test blood products before releasing them for administration. When transported to the patient for administration, regulations require the blood and patient be checked by two mid- or high-level health care providers (RN, PA, MD). Multiple variables are checked including name, date of birth, medical record number, blood type, “R” number, and blood unit number, among others. The checks are extensively documented in the medical record. While blood is carefully handled and instances of human errors rarely occur, those that do occur often have serious consequences. There are no known autonomously, continuously updated, operating safeguard systems that would give a real-time active warning of error in the administration of a blood product, or a drug or medication, to a patient in a hospital setting.

Generally speaking, hospital based clinical computer systems, are cumbersome, difficult for health care providers to learn, outdated, and have poor user interfaces. Put another way, they distract health care providers from providing health care while occupying them with data entry.

### SUMMARY OF THE INVENTION

According to one embodiment, a system for autonomous monitoring of administration of prescribed items for patients may include a plurality of wireless locator tags each having an indicator coupled thereto, an indoor positioning system configured to autonomously determine a location of each of the plurality of wireless locator tags as a function of time, a database configured to store the locations of each of the plurality of wireless locator tags as a function of time, the database comprising data representative of: patient location as a function of time; prescribed item location as a function of time; and staff member location as a function of time. The system may also include a processor to process data from the database, and a radio transceiver configured to transmit a command generated by the processor to the plurality of wireless locator tags, wherein the command is addressed to one of the plurality of wireless locator tags, and wherein the command causes the indicator of the addressed wireless tag to indicate a status condition with respect to the prescribed item as a function of location.

According to one embodiment, a method for autonomous monitoring of administration of prescribed items for patients may include autonomously detecting a contemporaneous collocation of a prescribed item and a patient, verifying that an identity of the prescribed item in contemporaneous collocation is equivalent to a prescribed item recorded in a physician's order for the patient, determining if the prescribed item is supplied in a correct dose according to the physician's order, determining if the prescribed item is in contemporaneous collocation with the patient at a time consistent with an administration schedule according to the physicians order, recording the identities of staff members in contemporaneous collocation to the patient, commanding a locator tag coupled to a container holding the prescribed item to annunciate an error condition if the identity of the prescribed item, the dosage, or the time of administration is not consistent with the physician's order, and commanding the locator tag coupled to the container holding the prescribed item to annunciate a no error condition if the identity of the prescribed item, the dosage, and the time of administration is consistent with the physician's order.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a schematic block diagram of a system 100 according to one embodiment of the invention.

FIG. 2 is a schematic block diagram of a system 200 according to another embodiment of the invention.

FIG. 3 is a flow diagram of a method in accordance with an embodiment of the invention.

FIG. 4 is a flow diagram of a method in accordance with an embodiment of the invention.

### DETAILED DESCRIPTION OF THE EXEMPLARY EMBODIMENTS

Reference will now be made in detail to the preferred embodiments of the present invention, examples of which are illustrated in the accompanying drawings.

What is needed is a system that autonomously utilizes continuously updated data from an indoor location determining system in combination with existing data from other databases, such as a clinical pharmacy database, a clinical patient database, an administrative patient database, and/or a blood bank database, to improve the safety of drug or medication and/or blood product delivery and administration. The exemplary descriptions provided hereinbelow are, for the most part, exemplified from the perspective of drug, medication, or blood product delivery and administration. It will be understood, however, that the system is not limited to delivery and administration of only these products and may provide benefit when applied to the delivery and administration of other medical or non-medical products as well.

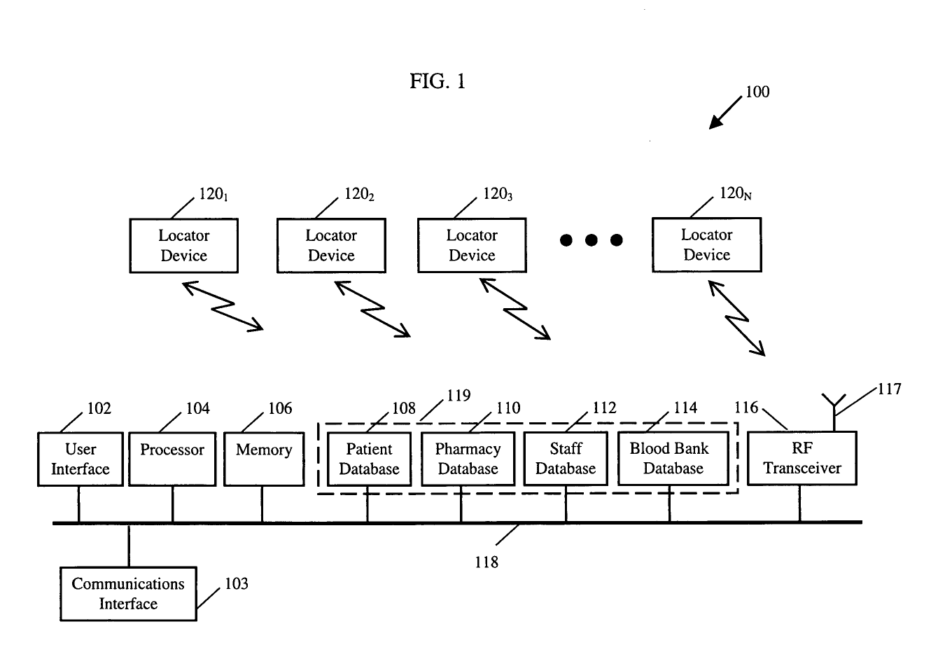

FIG. 1 is a schematic block diagram of a system 100 according to one embodiment of the invention. The system 100 includes a user interface 102, a communications interface 103, a processor 104, a memory 106, a patient database 108, a pharmacy database 110, a health care worker (staff) database 112, a blood bank database 114 and, a radio transceiver 116, all coupled to a communication bus 118. The user interface 102 may include a keyboard, mouse, and monitor (not shown). The communications interface 103 may be any interface that allows communication between, for example, various computers on a network. The processor 104 may execute instructions in accordance with a method of the invention. The memory 106 may store the instructions to be executed by the processor. Each of the databases 108, 110, 112, and 114 may be conventional databases as known in the art. While shown as individual databases, all data from two or more individual databases may be combined into one database, as represented by the dashed line 119 surrounding databases 108, 110, 112, and 114.

Databases may include information useful in the performance of a method in accordance with an embodiment the invention. The patient database 108 may include data relating to patient identity (such as name and social security number), address, insurance information, and the like. The pharmacy database 110 may include data related to the names, dosages, and quantities of prescribed items dispensed for each patient. The health-care provider information database 112 (hereinafter “staff database 112) may include data related to the identity, title, and the like of each health-care worker employed at the hospital, including data related to physicians having privileges at the hospital. The blood-bank database 114 may include data related to each blood product dispensed to each patient. The databases described above may also include data corresponding to the location of each locator tag as a function of time. Of course, location information could also be included in another database, or any subset of the databases described above. Additionally, the system 100 may make use of a remote database (not shown) that can store any or all data useful in performing the method of an embodiment of the invention.

Radio transceiver 116 may transmit to and receive from radio transceivers (not shown) in each locator tag 120₁, 120₂, 120₃, . . . , 120_{N}. In one embodiment, the radio signals may comprise modulated data in the instrument, scientific, and medical (ISM) bands. In one embodiment, the modulation and protocol may be according to any known standard, such as that standard known popularly as “Wi-Fi.” Radio signals to and from radio transceiver 116 may be transmitted and received via antenna 117. Radio frequency transceiver 116 may modulate data received from the processor 104 and demodulate data received from locator tags for use by the processor 104.

Locator tags 120₁, 120₂, 120₃, . . . , 120_{N} (where N is any integer) may each include a processor, memory, battery, transceiver, and antenna (not shown). Each of the locator tags 120₁, 120₂, 120₃, . . . , 120_{N} may be in communication with transceiver 116 in accordance with radio protocols known in the art. Communication may be bi-directional, to allow two-way communication between the processor 104 and each locator tag 120₁, 120₂, 120₃, . . . , 120_{N}. Each of the locator tags 120₁, 120₂, 120₃, . . . , 120_{N} may be assigned an identifier (for example an alphanumeric string) that uniquely identifies it from among the plurality of locator tags 120₁, 120₂, 120₃, . . . , 120_{N}. Each patient, each container of dispensed prescribed items, each health-care worker, and each dispensed blood product may be physically coupled to a different locator tag from among the plurality of locator tags 120₁, 120₂, 120₃, . . . , 120_{N}. As each locator tag is assigned a unique identifier, each thing (be it a person or object) coupled to a given locator tag can be uniquely identified. For example, the data corresponding to the unique identifier of any randomly selected locator tag coupled to a patient may be associated with that patient in the patient database 108. Likewise, for example, the data corresponding to the unique identifier of any other randomly selected locator tag coupled to a dispensed container of prescribed items may be associated with that dispensed container of prescribed items in the pharmacy database 110.

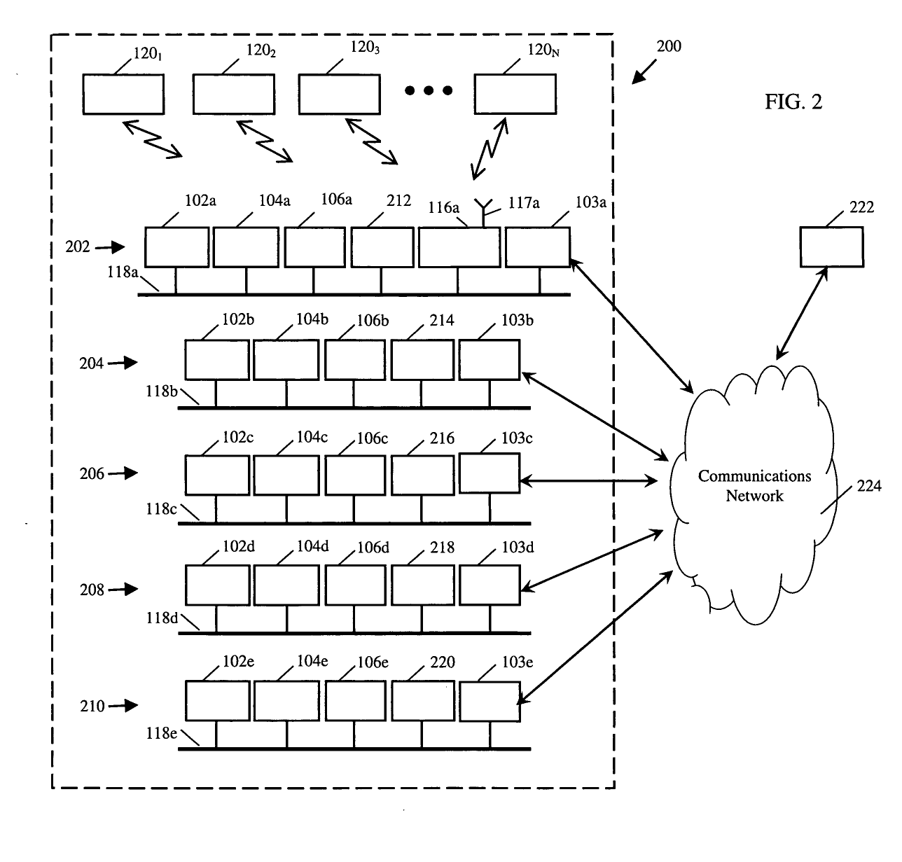

FIG. 2 is a schematic block diagram of a system 200 according to another embodiment of the invention. The system 200 includes five separate computer systems 202, 204, 206, 208, and 210. Each of the computer systems may include its own database. By way of example, the first computer system 202 may include a database configured to store data associated with the location of each locator tag 120 as a function of time. The second computer system 204 may include a database 214 that is similar to patient database 108 (FIG. 1). The third computer system 206 may include a database 216 that is similar to pharmacy database 110 (FIG. 1). The fourth computer system 208 may include a database 218 that is similar to staff database 112 (FIG. 1). The fifth computer system 210 may include a database 220 that is similar to blood bank database 114 (FIG. 1). Additionally, the system 200 may make use of a remote database 222 that can store any or all data useful in performing the method of an embodiment of the invention.

The system 200 may exemplify a networked system of computers. The computers 202, 204, 206, 208, 210 may each be associated with one or more hospital departments. These departments may include, for example: an executive administration department that may oversee the contents of a locator tag operations database 212; an admitting department that may oversee the contents of a patient database 214; a pharmacy department that may oversee the contents of a pharmacy database 216; an human resources department, that may oversee the contents of a staff database 218; and a hematology department that may oversee the contents of a blood bank database 220. In the exemplary embodiment of FIG. 2, a processor 104a of a first networked computer system 202 (e.g., locator tag operations department) may be able to access data in the databases 214, 216, 218, 220 of other departments and/or a collective or shared database 222. The data may be useful for performing a query in accordance with a method of the invention.

Exchange of data among the various databases may be via the communication interface 103 of each computer system, by way of a communications network 224. Communications network 224 may include wired and/or wireless networks. The communications interfaces 103 may be coupled to the communication network in a wired or wireless manner.

In one embodiment of the system 100, 200 described herein, the location determining system is continuously providing location information updates to the system. When a given locator tag is brought within a given and predetermined proximity of a given patient, a processor (such as processor 104 (FIG. 1) or processor 104a (FIG. 2)) may execute code that compares the identity and quantity of each prescribed item associated with a given locator tag with all prescribed items associated with Physician's Orders written for that patient (and recorded in accessible databases). A comparison may yield a positive result in the event of a match (meaning, for example, that a prescribed item was in the proximity of the patient at the correct time) or a negative result in the event of no match or a contraindication. Either a positive or a negative result may cause a transmission of a signal from the radio transceiver 116 (FIG. 1), 116a (FIG. 2), addressed to the locator tag 120 coupled to the given container. In the event of a positive result, the signal may command an indicator coupled to the locator tag to indicate an “All Clear” status. In the event of a negative result, the signal may command an indicator coupled to the container to indicate a “Danger” status and/or emit an audible and/or visual alarm. During that time period when a given locator tag is not brought within a given and predetermined proximity of a given patient, the processor 104 (FIG. 1), 104a (FIG. 2) may transmit a signal from the radio transceiver 116 (FIG. 1), 116a (FIG. 2), addressed to the locator tag 120 coupled to the given container, where the signal may command the indicator coupled to the container to remain off. That is, the indicator would not indicate any status. Alternatively, the indicator may indicate a neutral status or “NO STATUS.”

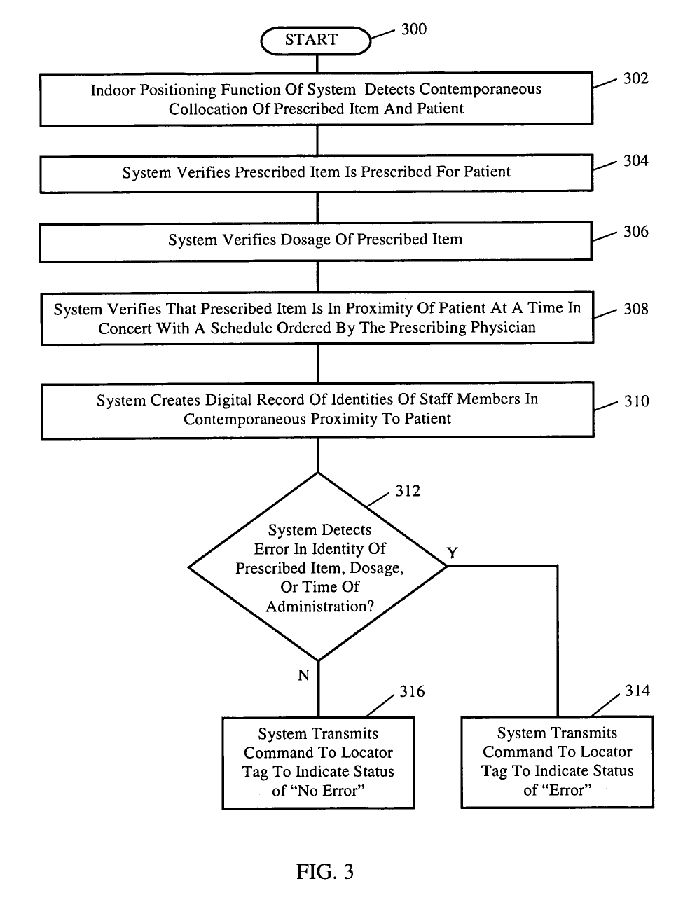

FIG. 3 is a flow diagram of a method in accordance with an embodiment of the invention. The method may begin at 300. At 302, when a prescribed item is brought to a patient, an indoor positioning system (e.g., ref. nos. 202 and 120 (FIG. 2)) may determine the contemporaneous co-location of the patient and prescribed item. That is, the indoor positioning system could supply location data to the CPU and the CPU could execute code to determine that the patient and prescribed item are in the same room. At 304, the system may verify that the prescribed item in proximity to the patient is the prescribed item that was prescribed for the patient. At 306, the system may determine if the prescribed item in proximity to the patient is supplied in the correct dose. At 308, the system may verify that the prescribed item in proximity to the patient is in proximity at a correct time (and therefore infer that the prescribed item was being administered according to the schedule set by the prescribing physician). At 310, a digital record may be made of the identities of the staff in contemporaneous proximity to the patient (thus providing a record of which members of the staff may have administered the prescribed item). The record of the identities of the staff may be supplemented with a recordation of the time that the staff member(s) were in contemporaneous co-location with the patient. Maintaining digital records in this manner may eliminate the need for a staff member to manually record this information. This information could also be used to verify data manually recorded by a staff member. At 312, the system determines there are errors in the identity of the prescribed item, the dosage, or the time of administration. If there are errors, then at 314 the system may command a red light to illuminate on the wireless locator tag coupled to the container holding the prescribed item. For added emphasis, the red light may flash and/or an audible alarm may sound. If however, at 312, the system determines there is no error in the identity of the prescribed item, the dosage, or the time of administration, the system may command a green light to illuminate on the wireless locator tag. Of course, other methods to indicate error or no error are acceptable and within the scope of the invention. In a preferred embodiment, all of the above-identified actions will occur within seconds.

It will be noted that the indoor location determining system (e.g., 202, FIG. 2) may operate continuously. Thus, it may collect and store a record of: the location of all locator tag equipped containers as a function of time; the location of all health care providers as a function of time; and the location of all patients as a function of time. According to one method, the recorded data may be queried to determine whether a given patient was within a given proximity of a given prescribed item at any time. If the result of the query is positive, the system may produce both the time of proximal location and the identities of all health care providers who were also in a given proximity of the patient at or around that time. The ability to rapidly produce this type of information could be extremely valuable in the investigation of a prescribed item administration error.

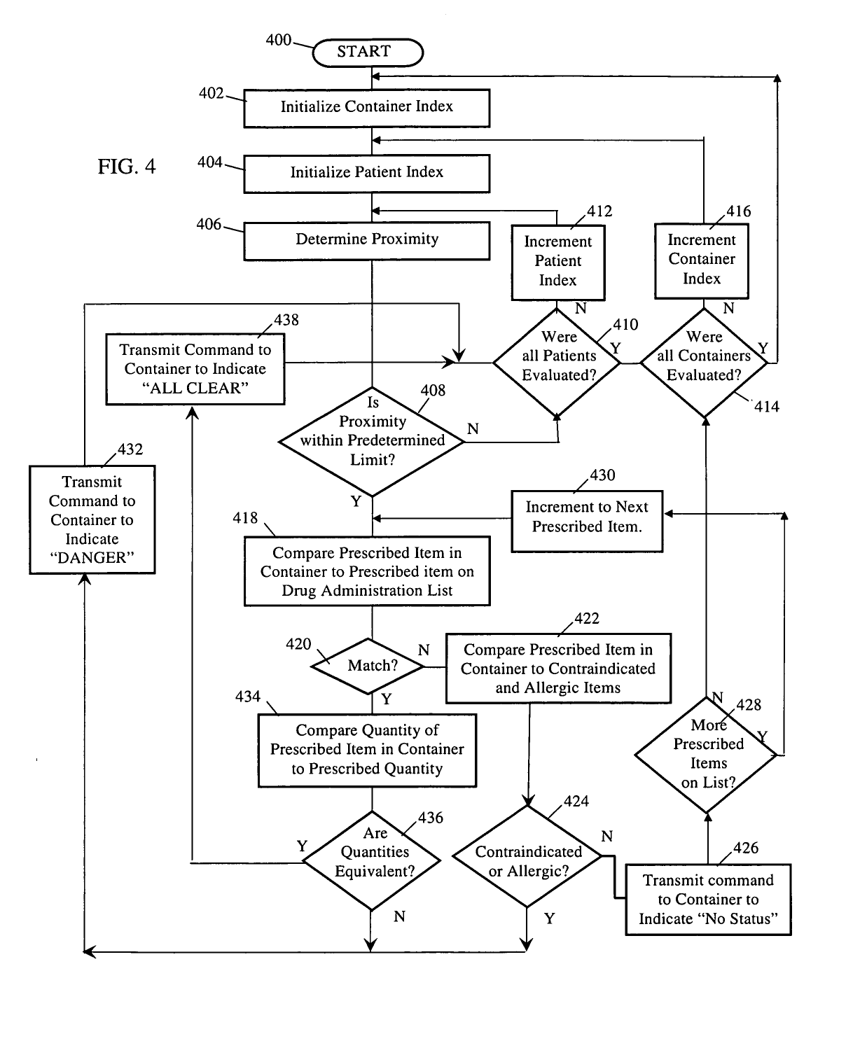

FIG. 4 is an in depth flow diagram of a method in accordance with an embodiment of the invention. The method may begin at 400. At 402, the index numbers for the list of containers is initiated (set to “1”) so that the first operation will commence with the first container. At 404, the index numbers for the list of patient identifications is initiated (set to “1”) so that the first operation will commence with the first patient. At 406, the proximity between the first container and first patient is determined. At 408, if the proximity is not within a predetermined limit, the method proceeds to 410. At 410, if all patients were not evaluated, the method proceeds to 412. At 412, the patient index is incremented (to evaluate the just evaluated container against the next patient on the patient list). The method then returns to 406. However, at 410, if all patients were evaluated, the patient index must be re-initiated. The method proceeds to 414. At 414, if all containers were not evaluated then the remaining containers must be evaluated against all remaining patients. Accordingly, the method proceeds to 416. At 416, the container index is incremented (to evaluate the next container). The method then returns to 404, to reinitialize the patient index. The method then returns to 406 and then on to 408.

At 408, if the proximity is within a predetermined limit, the method proceeds to 418, where the prescribed items in the container being evaluated are compared to the prescribed items on the Drug Administration List for the particular patient being evaluated. At 420, if there is not a match, the method proceeds to 422. At 422, it is determined if the prescribed item then being considered is contraindicated for any reason, such as in light of other prescribed items the patient is presently taking. Also at 422, it is determined if the prescribed item then being considered is on a list of prescribed items to which the patient may be allergic. At 424, if the prescribed item then being considered is not contraindicated and does not pose an allergic threat to the patient, then at 426 a command may be transmitted to the locator tag on the container to cause the locator tag on the container to indicate “NO STATUS.” The method the proceeds to 428, where it is determined if there are additional, unevaluated, prescribed items on the Drug Administration List that must be evaluated. If unevaluated prescribed items remain on the list, then the method proceeds to 430 to increment to the next prescribed item, and then on to 418 for comparison as described above. If, however, at 424 the prescribed item then being considered is contraindicated or does pose an allergic threat to the patient, then at 432, a command may be transmitted to the locator tag on the container to cause the locator tag on the container to indicate “DANGER.” The method then returns to 410.

Returning now to 420, if at 420 a match does exist between the prescribed item then being considered and a prescribed item on the Drug Administration List, the method proceeds to 434 where a comparison between the quantity of prescribed item dispensed for the patient is equivalent to the quantity prescribed for the patient. If at 436, the quantities are not equivalent, then the method proceeds to 432, where a command may be transmitted to the locator tag on the container to cause the locator tag on the container to indicate “DANGER.” The method then returns to 410. If, on the other hand, at 436, it is determined that the quantities are equivalent, then the method proceeds to 438, where a command may be transmitted to the locator tag on the container to cause the locator tag on the container to indicate “ALL CLEAR.” The method then returns to 410.

Of course, those of skill in the art will understand that the order of operations, from that described above, may change without affecting the scope of the invention. For example, instead of selecting a first container and then evaluating all patients against it before proceeding onto a next container, the method would work equally well by selecting a first patient and then evaluating all containers against that patient before proceeding onto a next patient. Moreover, those of skill in the art will recognize that advanced forms of logic and probabilities could be applied to the problem of comparing large numbers of containers to large numbers of patients; using advanced forms of logic and probabilities could result in a decrease in cycle time between re-initializations of either or both container and patient indexes.

The method may run autonomously to continuously collect and process data, comparing each locator tag equipped container to every patient within a predetermined proximity of the container. The autonomous and continually updated system and method described herein operates in a manner that is quite the opposite of how known systems and methods are operated today. Unlike known systems and methods that require human intervention to begin a comparison, the presently described embodiments continually and autonomously provide a level of safety for patients that is unsullied by human forgetfulness and error.

In one embodiment described herein, the system may automatically record the identities of contemporaneously co-located health care providers, patients, and containers (if any). In the event that a healthcare provider failed to note the administration of a prescribed item to a patient, the record of contemporaneously co-located health care providers, patients, and containers (if any) may be of great value in determining which health care provider or providers might have possibly administered one of a finite group of prescribed items from the record of contemporaneously co-located containers.

In another embodiment, the system may receive information from health care providers that could include an indication that the prescribed item in a given locator tag enabled container, was administered to a given patient. In such an embodiment, the health care worker would be required to discreetly identify a single container, from among a plurality of containers that was contemporaneously registering “All Clear” in a given proximity of a given patient. Alternatively, the system may receive information from health care providers that could include an indication that the prescribed items in all given locator tag enabled containers, registering “All Clear” in a given proximity of a given patient, were administered to the given patient.

In each of the above-identified embodiments, data relating to the administration of prescribed items could be stored in one or more databases. The collection and storage of this information could free healthcare providers from the burdens of data entry of mundane information.

With respect to delivery of blood product, the embodiments disclosed herein provide an additional layer of safety to the already extensive procedures mandated prior to the administration of a blood product to a patient. At least one advantage, with respect to delivery and administration of drugs, medications, and blood product is that the embodiments of the system described herein operate autonomously—they require no effort on the part of the clinical staff except for observation of the status indicator on a container holding the drug, medication, or blood product. The embodiments described herein autonomously and continuously monitor, evaluate, and provide dynamic indications of “All Clear” or “Danger” with respect to each unit of blood product, each drug, and each medication, in a given proximity of a given patient.

In practice, the methods according to embodiments of the invention described herein may be implemented as applications of existing indoor positioning systems (e.g., Ekahau, Aeroscout, Sonitor, etc.) and may interface with existing pharmacy software (many vendors) in a hospital setting. Pharmacy software is used currently to track, for example, the specifics of the patient's name, medical record number, medicines, dosages, times of administration, and patient's allergies.

In practice of the methods according to the embodiments described herein, all patients, physicians, and clinical staff will be given wireless locator tags so that their position in the hospital can continuously be determined in real-time by the autonomous operation of a system according to the present invention.

All intravenous medicines from the pharmacy will be given a locator tag. This tag could be, for example, the T-301-A Wi-Fi Tag (Ekahau) or a similar device (i.e. a RFID “smart label”). The locator tag may additionally employ a bar code or other mechanism to allow the determination of its uniquely assigned address or identity. The wireless locator tags may be integrated with alert systems. For example, each locator tag may have a green light, a red light, and an audible alarm. Alternatively, another alert system may be used.

Oral medicines from the pharmacy may be distributed in a container fitted with a wireless locator tag. In one embodiment, the container may be a lockable container. The container may have the capacity for remote unlocking via the locator tag circuitry and/or software. The lockable container may remain locked until it is within a predefined proximity of a predetermined patient, at which point it may be commanded to open.

An alternate embodiment in accordance with the invention may comprise a mobile medicine cart, which would be an improvement of existing mobile medicine dispensing products made, most commonly, by Pyxis (Cardinal Health). In the alternate embodiment, a mobile medicine cart would be adapted to be loaded, for example in a pharmacy, with multiple containers of prescribed items. Each container would be associated with a wireless locator tag. The association may be, for example, by direct attachment of a separate locator tag to each container in the cart. Each container would be in a default locked position, thereby preventing access to the prescribed items contained in each container. When the cart is brought to a patient, the system will detect the contemporaneous co-location of the cart and the patient. If a prescribed item is due to be administered to the patient, a proper container would unlock and dispensing/administering instructions may be given on a monitor. As in the other embodiments described herein, a digital record of the patient, prescribed item, dose, time, and staff in proximity may be recorded by the system, without the need for human intervention.

An additional alternate embodiment of the invention disclosed herein relates to remotely programmable IV pumps. The IV pump may be coupled to a wireless locator tag. The IV pump's location may be continuously determined by the system. The system may determine if the IV pump is in contemporaneous co-location with a patient. When an IV medicine (also coupled to an individual and distinct wireless locator tag) is delivered from the pharmacy, the nurse may connect the IV tubing to the pump and the patient. The system will check the IV medicine for accuracy (for example, in the same way as described hereinabove with respect to all drugs and medications). The pump will be remotely programmed by the system (eliminates programming errors) and started by the nurse. A digital record may be recorded for a Medical Administration Record (MAR). An alarm may sound, and the pump may be forced to an inoperative state if an error is identified in, for example, the IV medicine, dose, or time of administration. An emergency override function may be included.

What is Claimed is:

1. A system for autonomous monitoring of administration of prescribed items for patients, comprising:
a plurality of wireless locator tags each having an indicator coupled thereto;
an indoor positioning system configured to autonomously determine a location of each of the plurality of wireless locator tags as a function of time;
a database configured to store the locations of each of the plurality of wireless locator tags as a function of time, the database comprising data representative of:
patient location as a function of time;
prescribed item location as a function of time;
staff member location as a function of time;
a processor to process data from the database; and
a radio transceiver configured to transmit a command generated by the processor to the plurality of wireless locator tags, wherein the command is addressed to one of the plurality of wireless locator tags, and wherein the command causes the indicator of the addressed wireless locator tag to indicate a status condition with respect to the prescribed item as a function of location.

2. The system of claim 1, wherein the indoor positioning system is configured to continually update the location of each of the plurality of wireless locator tags as a function of time.

3. The system of claim 1, wherein the indoor positioning system is configured to update the location of each of the plurality of wireless locator tags according to a predetermined sequence.

4. The system of claim 1, wherein the prescribed item comprises at least one of a drug, a medication, and a blood products.

5. The system of claim 1, wherein the database is comprised of a plurality of databases.

6. The system of claim 1, wherein the processor continuously processes data to determine a contemporaneous collocation of a patient, a prescribed item, and a staff member.

7. The system of claim 6, wherein the collocation is defined as adjacent to the patient within a predetermined radius.

8. A method for autonomously monitoring of administration of prescribed items for patients, comprising:
autonomously detecting a contemporaneous collocation of a prescribed item and a patient;
verifying that an identity of the prescribed item in contemporaneous collocation is equivalent to a prescribed item recorded in a physician's order for the patient;
determining if the prescribed item is supplied in a correct dose according to the physician's order;
determining if the prescribed item is in contemporaneous collocation with the patient at a time consistent with an administration schedule according to the physician's order;
recording identities of staff members in contemporaneous collocation to the patient;
commanding a locator tag coupled to a container holding the prescribed item to annunciate an error condition if the identity of the prescribed item, the dosage, or the time of administration is not consistent with the physician's order; and
commanding the locator tag coupled to the container holding the prescribed item to annunciate a no error condition if the identity of the prescribed item, the dosage, and the time of administration is consistent with the physician's order.

9. The method of claim 8, wherein the locator tag annunciates an error message by illuminating a colored light.

10. The method of claim 9, wherein the colored light is on the locator tag.

11. The method of claim 9, wherein the colored light blinks at a predetermined rate.

12. The method of claim 9, wherein the locator tag annunciates an error message by sounding an audible alarm.

13. The method of claim 8, wherein the locator tag annunciates a no error condition by illuminating a colored light having a different color than that used to annunciate an error condition.

14. The method of claim 8, further comprising:
commanding the locator tag coupled to the container to lock the container to prevent access to the prescribed item therein if the identity of the prescribed item, the dosage, or the time of administration is not consistent with the physician's order.

15. The method of claim 8, further comprising:
commanding the locator tag coupled to the container to unlock the container to allow access to the prescribed item therein if the identity of the prescribed item, the dosage, and the time of administration are consistent with the physician's order.

16. The method of claim 8, wherein the prescribed item comprises at least one of a drug, a medication, and a blood product.
